(19) United States
(12) Patent Application Publication
(10) Pub. No.: US 2018/0139350 A1
(43) Pub. Date: May 17, 2018

(54) INFORMATION PROCESSING APPARATUS, INFORMATION PROCESSING METHOD, AND MEDIUM

(71) Applicant: Suntao YAN, Kanagawa (JP)

(72) Inventor: Suntao YAN, Kanagawa (JP)

(21) Appl. No.: 15/797,362

(22) Filed: Oct. 30, 2017

(30) Foreign Application Priority Data
Nov. 15, 2016 (JP) 2016-222245

(51) Int. Cl. H04N 1/32

(52) U.S. Cl. CPC H04N 1/32651; H04N 1/32625

(57) ABSTRACT

An apparatus includes circuitry configured to monitor a status of the apparatus to generate time-series status information indicating the statuses of the apparatus in chronological order, at every regular reporting time, acquire first status information indicating the status of the apparatus at the regular reporting time, and report the first status information to an information processing apparatus via a network, and after regular reporting of the first status information, acquire second status information that has not been reported to the information processing apparatus, from among the time-series status information being generated, and report the second status information to the information processing apparatus.

### CROSS-REFERENCE TO RELATED APPLICATION

This patent application is based on and claims priority pursuant to 35 U.S.C. § 119(a) to Japanese Patent Application No. 2016-222245, filed on Nov. 15, 2016 in the Japan Patent Office, the entire disclosure of which is hereby incorporated by reference herein.

### BACKGROUND

### Technical Field

The present invention relates to an information processing apparatus, an information processing system, and an information processing method.

### Background Art

Conventionally, in order to analyze apparatuses located at customer's environment by using information processing apparatuses such as servers located at remote environment, a technology that the apparatus remotely reports information to the information processing apparatus (via a network) is known. For example, a technology that a copier regularly reports internal information of the copier, environmental information of the copier, and use information of the copier to a failure prediction apparatus is known.

### SUMMARY

Example embodiments of the present invention provide a novel information processing apparatus that includes circuitry configured to monitor a status of the apparatus to generate time-series status information indicating the statuses of the apparatus in chronological order, at every regular reporting time, acquire first status information indicating the status of the apparatus at the regular reporting time, and report the first status information to an information processing apparatus via a network, and after regular reporting of the first status information, acquire second status information that has not been reported to the information processing apparatus, from among the time-series status information being generated, and report the second status information to the information processing apparatus.

Further example embodiments of the present invention provide an information processing method, and a system for controlling communication.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating the configuration of an information processing system according to an example embodiment of the present invention;

FIG. 2 is a block diagram illustrating the hardware configuration of an apparatus according to an example embodiment of the present invention;

FIG. 3 is a block diagram illustrating the hardware configuration of an information processing apparatus according to an example embodiment of the present invention;

FIG. 4 is a block diagram illustrating the software configuration of the apparatus according to an example embodiment of the present invention;

FIG. 5 is a block diagram illustrating a functional configuration of the information processing system according to an example embodiment of the present invention;

FIG. 6 is a sequence chart illustrating an operation of generating status information in chronological order performed by the information processing system according to an example embodiment of the present invention;

FIG. 7 is a sequence chart illustrating an operation of reporting first status information and second status information performed by the information processing system according to an example embodiment of the present invention;

FIG. 8 is a sequence chart illustrating an operation of reporting target information and the second status information performed by the information processing system according to an example embodiment of the present invention;

FIG. 9 is a flowchart illustrating an operation of reporting performed by the information processing system according to an example embodiment of the present invention;

FIG. 10 is a diagram illustrating a specific operation of reporting the first status information and second status information performed by the information processing system according to an example embodiment of the present invention;

FIG. 11 is a diagram illustrating a specific operation of reporting the target information and third status information performed by the information processing system according to an example embodiment of the present invention;

FIG. 12 is a flowchart illustrating an operation of determining second status information performed by the apparatus according to an example embodiment of the present invention;

FIG. 13 is a flowchart illustrating an operation of determining third status information performed by the apparatus according to an example embodiment of the present invention;

FIG. 14 is a sequence chart illustrating an operation of writing information indicating whether or not it is required to report performed by the information processing system according to an example embodiment of the present invention;

FIG. 15 is a sequence chart illustrating an operation of reporting the target information and the second status information performed by the information processing system according to an example embodiment of the present invention, and

FIG. 16 is a flowchart illustrating an operation of reporting performed by the information processing system according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

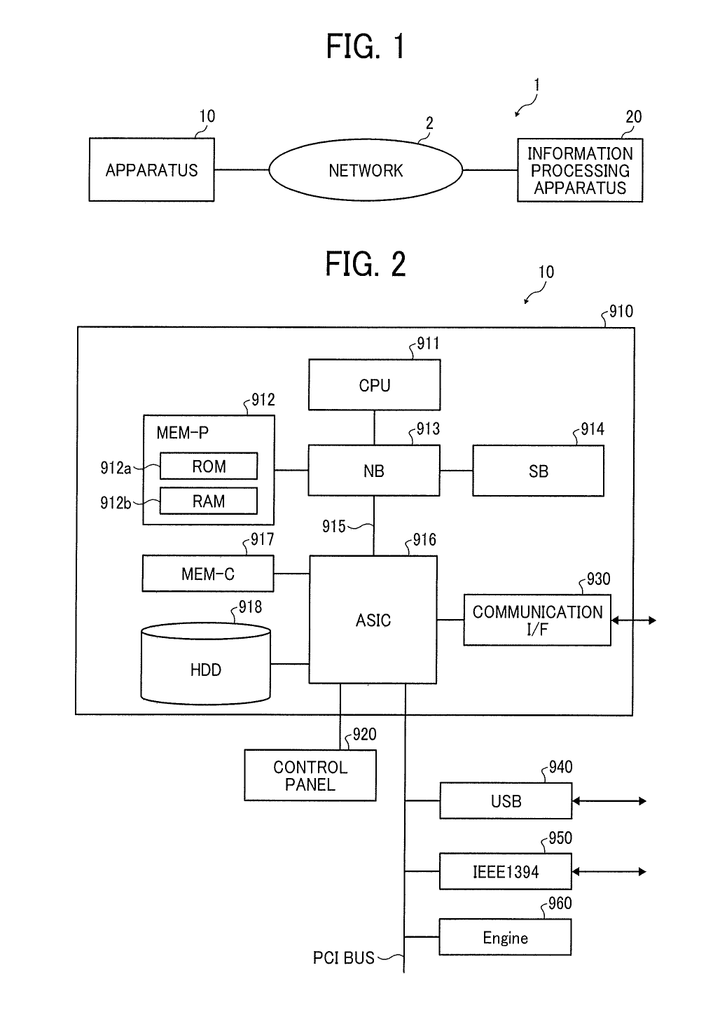

Embodiments are described below in detail with reference to figures. FIG. 1 is a block diagram illustrating the configuration of an information processing system 1 in this embodiment. As illustrated in FIG. 1, the information processing system 1 includes an apparatus 10 and an information processing apparatus 20. The apparatus 10 and the information processing apparatus 20 are connected to each other through a network 2. For example, the network 2 may be implemented by using the Internet and a local area network (LAN) etc.

Any apparatus such as an electronic apparatus, a medical apparatus, and an industrial apparatus etc. capable of communication via the network 2 may be used as the apparatus 10. Examples of the electronic apparatus are an image forming apparatus such as a printer, copier, multifunction peripheral (MFP), scanner, and facsimile device etc., a projector, a camera, a network home appliance, a fluorescent lamp, a vending machine, and a handheld device etc. However, the electronic apparatus is not limited to those examples. The MFP includes at least two functions among a copy function, a print function, a scan function (a scanner function), and a facsimile function. Examples of the medical apparatus are a fundus examination apparatus, an X-ray examination apparatus, a blood-pressure meter, a body fat monitor, an eyesight-test monitor, and a pacemaker etc. However, the medical apparatus is not limited to those examples. Examples of the industrial apparatus are a power source device, an air-conditioning system, and a measurement system for gas, water, and electricity etc. However, the industrial apparatus is not limited to those examples.

In this embodiment, the apparatus 10 is the image forming apparatus, and the apparatus 10 is sold or leased to a customer by a manufacturer and a vendor who manages the information processing apparatus 20 and located at the customer's place as an example. However, the configuration of the embodiment is not limited to that example. It should be noted that only one apparatus 10 is illustrated in FIG. 1. However, there may be more than one apparatus 10.

FIG. 2 is a block diagram illustrating the hardware configuration of the apparatus 10 in this embodiment. As illustrated in FIG. 2, the apparatus 10 includes a controller 910 and an engine 960 connected with each other via a PCI bus. The controller 910 is a controller that controls entire operation performed by the apparatus 10, such as operation of rendering an image, communicating with other device or apparatus, and processing input from a control panel 920. The engine 960 is an engine that can be connected to the PCI bus such as a scan engine of the scanner etc. for example. The engine 960 includes an image processing unit such as error diffusion and gamma conversion etc. in addition to the engine unit.

The controller 910 includes a central processing unit (CPU) 911, a Northbridge (NB) 913, a system memory (MEM-P) 912, a Southbridge (SB) 914, a local memory (MEM-C) 917, an application specific integrated circuit (ASIC) 916, and a hard disk drive (HDD) 918, and the NB 913 is connected to the ASIC 916 via an Accelerated Graphics Port (AGP) bus 915. In addition, the MEM-P 912 further includes a read only memory (ROM) 912a and a random access memory (RAM) 912b.

The CPU 911 controls the entire apparatus 10 and is connected to other apparatuses via a chipset including the NB 913, MEP-P 912, and SB 914.

The NB 913 is a bridge that connects the CPU 911 to the MEM-P 912, SB 914, and AGP bus 915 and includes a memory controller that controls reading data from the MFM-P 912 and writing data in the MEM-P 912, a PCI master, and an AGP target.

The MEM-P 912 is a system memory used as a memory for storing programs and data, a memory as an area where programs and data are deployed, and a memory for storing rendered data to be used by the printer etc., and the MEM-P 912 includes a ROM 912a and a RAM 912b. The ROM 912a is a read-only memory used for storing programs and data, and the RANI 912b is a volatile readable/writable memory that can be used as a memory for expanding programs and data and a memory for storing rendered data used by the printer etc.

The SB 914 serves as a bridge between the NB 913, PCI devices, and peripheral devices. The SB 914 is connected to the NB 913 via the PCI bus.

The ASIC 916 is an integrated circuit (IC) for processing images including a hardware component for image processing and serves as a bridge between the AGP bus 915, PCI bus, HDD 918, and MEM-C 917. The ASIC 916 includes the PCI target, AGP master, an arbiter (ARB) as a central core of the ASIC 916, a memory controller that controls the MEM-C 917, multiple Direct Memory Access Controllers (DMACs) that rotates coordinates of image data etc. using a hardware logic etc., and a PCI unit that transfers data to the engine 960 via the PCI bus. A USB 940 and an Institute of Electrical and Electronics Engineering (IEEE) 1394 interface (I/F) 950 are connected to the ASIC 916 via the PCI bus. The control panel 920 and a communication I/F 930 are connected to the ASIC 916 directly.

The MEM-C 917 is a local memory used as an image buffer for copying and a decoding buffer, and the HDD 918 is a storage used for storing image data, program, font data, and form.

The AGP bus 915 is a bus interface for a graphics accelerator card, which enables high-speed processing of the graphics accelerator card by accessing the MEM-P 912 directly at high throughput.

The information processing apparatus 20 is managed by a service provider such as the manufacturer and the vendor etc. described above. The information processing apparatus 20 corresponds to a server apparatus that remotely manages the apparatus 10, which has been sold or leased to the customer by the service provider. For example, the information processing apparatus 20 may be implemented by using one or more computers. In this embodiment, the information processing apparatus 20 is implemented by using one computer. However, that is just an example, and the information processing system may be implemented by using two or more computers.

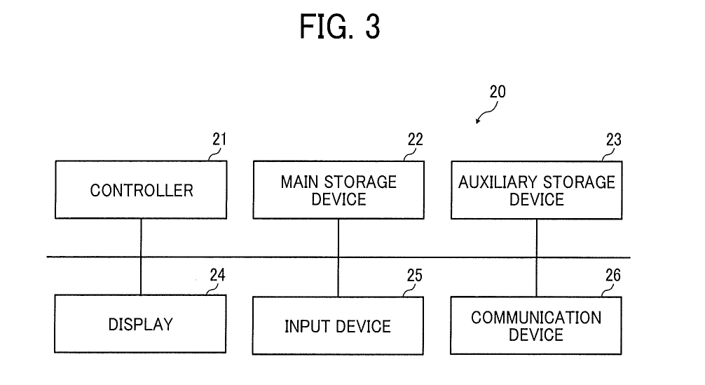

FIG. 3 is a block diagram illustrating the hardware configuration of the information processing apparatus 20 in this embodiment. The information processing apparatus 20 includes a controller 21 such as a CPU and a graphic processing unit (GPU) etc., a main storage device 22 such as a ROM and RAM etc. an auxiliary storage device 23 such as a HDD and solid state drive (SSD) etc., a display 24 such as a liquid crystal display, etc., an input device 25 such as a keyboard and a mouse etc., and a communication device 26 such as a communication interface etc. The information processing apparatus 20 includes a hardware configuration using a general-purpose computer.

In the information processing system 1, in order to implement remote management by the information processing apparatus 20, the apparatus 10 and the information processing apparatus 20 may respectively exchange requests and responses with respect to a method of an application, installed mutually for both apparatuses, using Remote Procedure Call (RPC). RPC may be implemented by performing communication using protocols such as Point to Point Protocol (PPP), Transmission Control Protocol/Internet Protocol (TCP/IP), Simple Object Access Protocol (SOAP), HyperText Transfer Protocol (HTTP), and HyperText Transfer Protocol Secure (HTTPS) etc.

In addition, in this embodiment, notification from the information processing apparatus 20 to the apparatus 10 is reported in the form of a response to pooling performed regularly from the apparatus 10 to the information processing apparatus 20. As a result, even in a situation that access from outside to the information processing apparatus 20 is prevented by a packet filtering function etc. of a firewall, the information processing apparatus 20 can manage the apparatus 10 remotely.

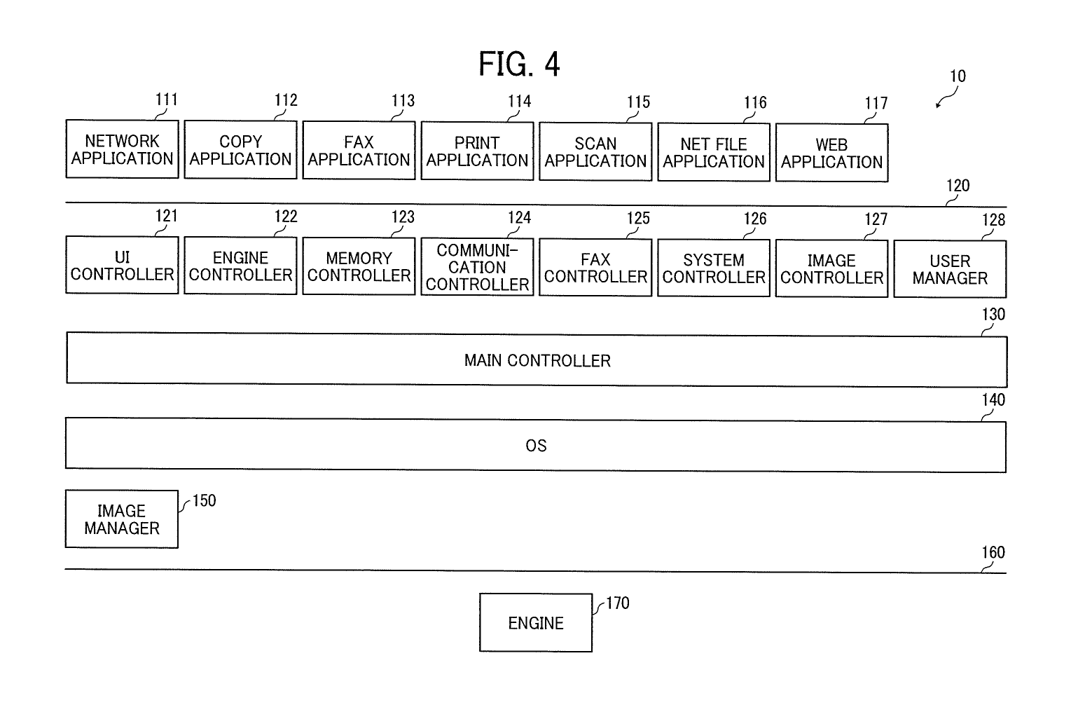

FIG. 4 is a block diagram illustrating the software configuration of the apparatus 10 in this embodiment. As illustrated in FIG. 4, the apparatus 10 includes software in an application layer such as a network application 111, copy application 112, facsimile application 113, print application 114, scan application 115, netfile application 116, and web application 117 for browsing web pages.

The network application 111 is application for performing communication via the network 2, for example, to report status information indicating a status of the apparatus 10, counter information, and firmware version information to the information processing apparatus 20, and report to the information processing apparatus 20 that malfunction is detected such as error and shortage of supplies etc.

Hereinafter, information to be reported regularly, i.e., each time that is preliminarily set, such as every predetermined interval, is simply referred to as “report”, and includes, for example, the status information, counter information, and firmware version information etc. The information to be reported at an irregular time, for example, when the malfunction occurs, etc. is simply referred to as “call”.

As illustrated in FIG. 4, the apparatus 10 includes software in a service layer, which operates as an UI controller 121, an engine controller 122, a memory controller 123, a communication controller 124, a facsimile controller 125, a system controller 126, an image controller 127 that controls transferring image files, and a user manager 128 that manages user information.

The engine controller 122 controls the engine 170. Examples of the engine 170 are a plotter and a scan engine etc. However, the engine 170 is not limited to those examples.

The communication controller 124 controls communication to be performed between the network 2 and application in the application layer in communicating with outside.

The system controller 126 arbitrates tasks between applications in the application layer, and services in the service layer and the engine 170.

Each application in the application layer exchanges data with each service in the service layer via the interface 120.

The main controller 130 controls the system and manages resources.

For example, generic operating system (OS) such as UNIX (registered trademark) and LINUX (registered trademark) may be used as the OS 140.

The image manager 150 manages a memory that stores an image temporarily.

It should be noted that the engine 170 exchanges data with each service in the service layer, the main controller 130, the OS 140, and the image manager 150 via the interface 160.

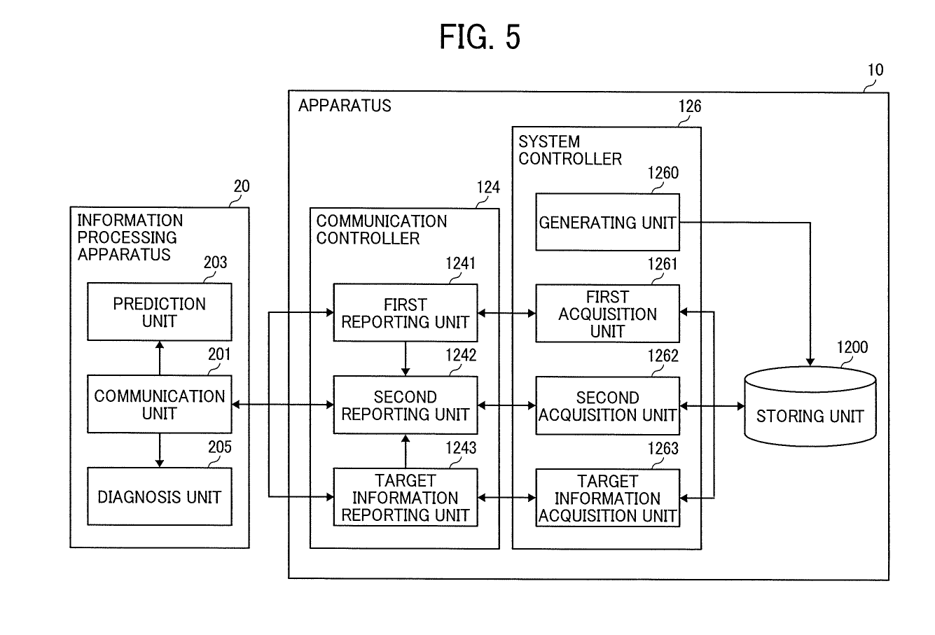

FIG. 5 is a block diagram illustrating a functional configuration of the information processing system 1 in this embodiment. As illustrated in FIG. 5, the apparatus 10 includes the communication controller 124, the system controller 126, and the storing unit 1200. The communication controller 124 includes a first reporting unit 1241, a second reporting unit 1242, and a target information reporting unit 1243. The system controller 126 includes a generating unit 1260, a first acquisition unit 1261, a second acquisition unit 1262 (as an example of a second acquisition unit and a status information acquisition unit), and a target information acquisition unit 1263.

The communication controller 124 (i.e., the first reporting unit 1241, the second reporting unit 1242, and the target information reporting unit 1243) may be implemented by using the CPU 911, the MEM-P (the system memory) 912, and the communication I/F 930 etc. for example. The system controller 126 (i.e., the generating unit 1260, the first acquisition unit 1261, the second acquisition unit 1262, and the target information acquisition unit 1263) may be implemented by using the CPU 911 and the MEM-P (the system memory) 912 etc. The storing unit 1200 may be implemented by using the HDD 918 etc. for example.

In addition, as illustrated in FIG. 5, the information processing apparatus 20 includes a communication unit 201, a prediction unit 203, and a diagnosis unit 205. The communication unit 201 may be implemented by using the controller 21, the main storage device 22, and the communication device 26 etc. for example. The prediction unit 203 and the diagnosis unit 205 may be implemented by using the controller 21 and the main storage device 22 etc. for example.

The generating unit 1260 monitors the status of the apparatus 10 and generates time-series status information indicating the statuses of the apparatus 10 in chronological order. More specifically, after the status of the apparatus 10 is detected and it is requested to record (log) the status information by applications in the application layer, services in the service layer, and the engine 170 etc., the system controller 126 generates the time-series status information (log information) by writing the requested status information in the storing unit 1200 in chronological order.

It should be noted that each of the applications, services, and the engine 170 detects statuses different from each other respectively since each of the applications, services, and the engine 170 detects the status of the apparatus 10 related to their operations. In addition, the status information requested to be recorded (log) by the applications, services, and the engine 170 may be information indicating the detected status itself. Otherwise, the status information may be information that the status detected by the applications, services, and the engine 170 is processed (for example, information indicating an analysis result and information indicating detected status whose degree of incidence to occurrence of malfunction is large).

Examples of the status information are sensed values such as a voltage value, current value, toner concentration, and conveyance time of paper (detection timing) etc. and a pair of time information indicating date/time when the value is sensed. However, the status information is not limited to those examples.

At every predetermined interval, the first acquisition unit 1261 acquires first status information indicating a current status of the apparatus 10. The predetermined interval is set as a time when the status of the apparatus 10 is reported to the information processing apparatus 20, and configured preliminarily according to the user preference such as at 0:00 every day. Such predetermined interval set as the reporting time is referred to as a regular reporting time.

More specifically, at the regular reporting time, the first acquisition unit 1261 requests the applications, services, and engine 170 etc. to detect the current status of the apparatus 10 to acquire the first status information indicating the current status of the apparatus 10. If information stored in the MEM-P 912 and the HDD 918 is to be included in the first status information, the first acquisition unit 1261 also acquires information from the MEM-P 912 and the HDD 918. Examples of the information described above are version information of firmware in the apparatus 10, a counter value (a number of printed sheets), and serial number of the apparatus 10 etc. However, the information is not limited to those examples. It should be noted that information that should not be initialized such as the counter value and the serial number etc. is not basically stored in the HDD 918 but stored in the MEM-P 912.

Regarding the status of the engine 170, in case the engine 170 is in energy-saving mode, information at timing just before the engine 170 transitions to the energy-saving mode is stored in the MEM-P 912 or the HDD 918. The first acquisition unit 1261 may acquire the first status information of the engine 170 from the MEM-P 912 or the HDD 918. As a result, the first status information of the engine 170 can be acquired while maintaining the energy-saving mode of the engine 170, thus, keeping the energy-saving effect.

The first reporting unit 1241 detects the regular reporting time described above and requests the first acquisition unit 1261 to acquire the first status information. After the first acquisition unit 1261 acquires the first status information, the first reporting unit 1241 reports the first status information to the information processing apparatus 20. It should be noted that, after reporting the first status information, the first reporting unit 1241 acquires a result of reporting the first status information in the form of a response from the information processing apparatus 20, checks whether or not it has succeeded to report the first status information, and reports the result of reporting to the second reporting unit 1242.

After reporting the first status information by the first reporting unit 1241, the second acquisition unit 1262 further acquires the second status information of the time-series status information stored in the storing unit 1200, which has not been reported to the information processing apparatus 20. More specifically, the second acquisition unit 1262 acquires, from among the time-series status information stored in the storing unit 1200, status information corresponding to a time period from the date/time when the second status information was reported to the information processing apparatus 20 last time to the current date/time, as the second status information that has not been reported to the information processing apparatus 20.

If the first reporting unit 1241 successfully reported the first status information, the second acquisition unit 1262 acquires the second status information. If the first reporting unit 1241 fails to report the first status information, the second acquisition unit 1262 does not acquire the second status information.

After the second acquisition unit 1262 acquires the second status information, the second reporting unit 1242 transmits the second status information to the information processing apparatus 20. More specifically, after the second reporting unit 1242 is reported that the first status information has been successfully reported by the first reporting unit 1241, the second reporting unit 1242 requests the second acquisition unit 1262 to acquire the second status information, acquires the second status information from the second acquisition unit 1262, and reports the second status information to the information processing apparatus 20. It should be noted that, after the second reporting unit 1242 is reported that reporting of the first status information by the first reporting unit 1241 has failed, the second reporting unit 1242 does not request the second acquisition unit 1262 to acquire the second status information, and does not report the second status information to the information processing apparatus 20.

Subsequently, after reporting the second status information, the second reporting unit 1242 acquires a result of reporting the second status information as a response from the information processing apparatus 20, checks whether or not reporting of the second status information was successful, and reports the result of reporting to the second acquisition unit 1262. After the second acquisition unit 1262 is reported that reporting of the second status information by the second reporting unit 1242 was successful, the second acquisition unit 1262 sets the current date/time used for defining the range of the second status information described above (i.e., the latest date/time included in the second status information) as the latest date/time when the second status information was successfully reported to the information processing apparatus 20. It should be noted that the second acquisition unit 1262 does not perform the operation described above in case when the notification received from the second reporting unit 1242 indicates that reporting of the second status information has failed.

When the malfunction occurs in the apparatus 10, the target information acquisition unit 1263 acquires the target information to be reported when the malfunction occurs. The time when the report is to be transmitted when the malfunction occurs in the apparatus 10 is the time for calling.

More specifically, when the malfunction occurs in the apparatus 10, the target information acquisition unit 1263 acquires the target information by requesting applications, services, or the engine related to the malfunction. The content of the target information to be acquired depends on the type of the malfunction. Basically, an example of the content of the target information is a value sensed by a sensor etc. such as the status information described above. For example, if the malfunction is sequential jam (sequential paper jam), an example of the target information is conveyance time of paper (detection timing) etc.

If information stored in the MEM-P 912 and the HDD 918 is to be included in the target information, the target information acquisition unit 1263 also acquires the information from the MEM-P 912 and the HDD 918. Examples of the information described above are version information of firmware in the apparatus 10, a counter value (a number of printed sheets), and serial number of the apparatus 10 etc. However, the information is not limited to those examples.

The target information reporting unit 1243 detects the occurrence of a malfunction in the apparatus 10 described above to determine a reporting time, and requests the target information acquisition unit 1263 to acquire the target information. For example, the target information reporting unit 1243 detects the malfunction based on a notification received from the applications, services, and engine related to the occurred malfunction. After the target information acquisition unit 1263 acquires the target information, the target information reporting unit 1243 reports the target information to the information processing apparatus 20.

It should be noted that, after reporting the target information, the target information reporting unit 1243 acquires a result of reporting the target information as a response from the information processing apparatus 20, checks whether or not it has succeeded to report the target information, and reports the result of reporting to the second reporting unit 1242.

After reporting the target information by the target information reporting unit 1243, the second acquisition unit 1262 acquires third status information (status information) that has been obtained during a predetermined period of time up to the time when the malfunction occurs, from among the time-series status information stored in the storing unit 1200. More specifically, the second acquisition unit 1262 acquires status information that has been obtained during a predetermined period of time (e.g., three hours ago) up to the time when the malfunction occurs, as the third status information, from among the time-series status information stored in the storing unit 1200.

If the target information reporting unit 1243 succeeds to report the target information, the second acquisition unit 1262 acquires the third status information. If the target information reporting unit 1243 fails to report the target information, the second acquisition unit 1262 does not acquire the third status information.

After the second acquisition unit 1262 acquires the third status information, the second reporting unit 1242 reports the third status information (reports the status information) to the information processing apparatus 20. More specifically, after the second reporting unit 1242 is reported that reporting of the target information by the target information reporting unit 1243 was successful, the second reporting unit 1242 requests the second acquisition unit 1262 to acquire the second status information, acquires the third status information from the second acquisition unit 1262, and reports the third status information to the information processing apparatus 20. It should be noted that, after the second reporting unit 1242 is reported that reporting of the target information by the target information reporting unit 1243 failed, the second reporting unit 1242 does not request the second acquisition unit 1262 to acquire the third status information and does not report the third status information to the information processing apparatus 20.

After receiving the first status information from the apparatus 10, the communication unit 201 transfers the result of reporting the first status information to the apparatus 10 as a response. In addition, after receiving the second status information from the apparatus 10, the communication unit 201 transfers the result of reporting the second status information to the apparatus 10 as a response. In addition, after receiving the target information from the apparatus 10, the communication unit 201 transfers the result of reporting the target information to the apparatus 10 as a response. In addition, after receiving the third status information from the apparatus 10, the communication unit 201 transfers the result of reporting the third status information to the apparatus 10 as a response.

Based on the first status information and the second status information received from the communication unit 201, the prediction unit 203 predicts a future status of the apparatus 10. For example, the prediction unit 203 predicts a time when a malfunction occurs in the apparatus 10 in the future.

For example, by using the first status information, the prediction unit 203 analyzes fluctuation in statuses of the apparatus reported in a time interval longer than the regular time interval when the first status information is regularly reported, to predict a time when the malfunction attributable to wear of the apparatus 10 occurs. In addition, for example, by using the second status information, the prediction unit 203 analyzes fluctuation in statutes of the apparatus observed in a time interval shorter than the regular time interval for reporting, such as the fluctuation in statuses of the apparatus that occurs suddenly, to predict a next time when the malfunction occurs attributable to the status fluctuation.

Based on the target information and the second status information received from the communication unit 201, the diagnosis unit 205 diagnoses the malfunction that occurs in the apparatus 10.

It should be noted that, for example, the diagnosis unit 205 diagnoses the outline of the malfunction that occurs in the apparatus 10 by using the target information, and diagnoses the detail of the malfunction that occurs in the apparatus 10 by using the third status information. As a result, after the diagnosis, a customer engineer in charge of the customer of the apparatus 10 is selected, or a method how to cope with the malfunction is reported to the customer etc.

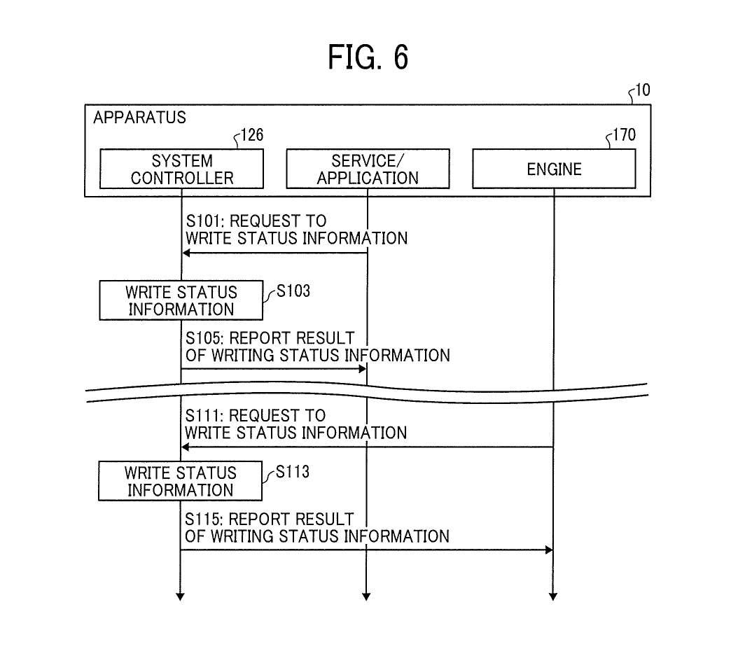

FIG. 6 is a sequence chart illustrating an operation of generating status information in chronological order performed by the information processing system 1 in this embodiment.

First, when the current time reaches the time to detect the status of the apparatus 10, the service or application detects the status of the apparatus 10 and requests the system controller 126 to write information as the status information in S101.

Next, the generating unit 1260 of the system controller 126 writes the status information in the storing unit 1200 in chronological order to generate the time-series status information in S103.

Subsequently, the generating unit 1260 reports the result of writing to the service or application that requested to write in S105.

Here, the operations in steps S101 to S105 are performed at a predetermined time interval, and the time interval may vary depending on the service or application. The system controller 126 may request the system controller 126 itself to write the status information.

Next, when the current time reaches the time to detect the status of the apparatus 10, the engine 170 detects the status of the apparatus 10 and requests the system controller 126 to write information as the status information in S111.

Next, the generating unit 1260 of the system controller 126 writes the status information in the storing unit 1200 in chronological order, to generate the time-series status information in S113.

Subsequently, the generating unit 1260 reports the result of writing to the engine 170 in S115.

Here, the operations in steps S111 to S115 are performed at a predetermined time interval. This time interval may be different from the time interval for detecting the status information requested by the service and application.

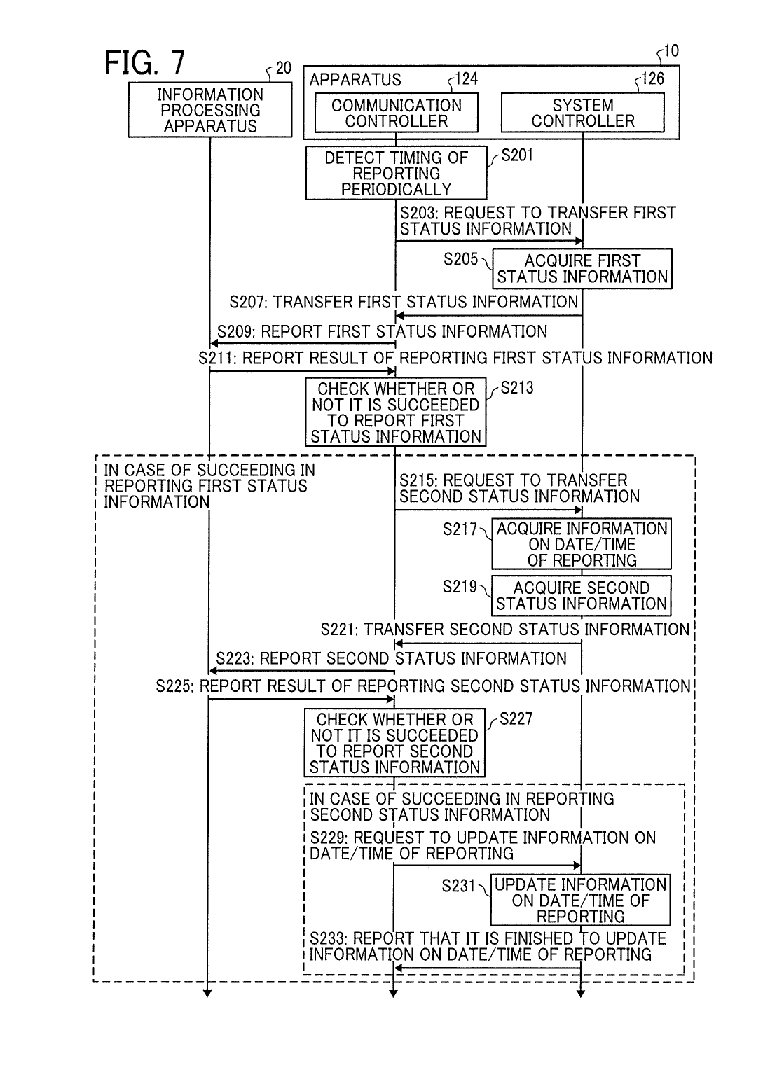

FIG. 7 is a sequence chart illustrating an operation of reporting first status information and second status information performed by the information processing system 1 in this embodiment.

At the regular reporting time in S201, the first reporting unit 1241 in the communication controller 124 requests the first acquisition unit 1261 in the system controller 126 to acquire the first status information in S203.

Subsequently, the first acquisition unit 1261 acquires the first status information in S205 to report the first status information to the first reporting unit 1241 in S207.

Next, the first reporting unit 1241 reports the first status information acquired by the first acquisition unit 1261 to the information processing apparatus 20 in S209. The first reporting unit 1241 acquires a result of reporting the first status information as a response from the information processing apparatus 20 in S211. The first reporting unit 1241 checks whether or not it has succeeded to report the first status information in S213.

Here, the operations after step S215 are performed if the first reporting unit 1241 has succeeded to report the first status information, and the operations after step S215 are not performed if the first reporting unit 1241 has failed to report the first status information.

Next, if the first reporting unit 1241 has succeeded to report the first status information, the first reporting unit 1241 reports to the second reporting unit 1242 in the communication controller 124 that it has succeeded to report the first status information, and the second reporting unit 1242 requests the second acquisition unit 1262 in the system controller 126 to acquire the second status information in S215.

Next, the second acquisition unit 1262 acquires information on reported date/time stored in the MEM-P 912 in S217. Here, the information on reported date/time indicates the last date/time when it has succeeded to report the second status information.

Next, the second acquisition unit 1262 acquires status information from the date/time when it has succeeded to report the second status information last time, as indicated by the information on reported date/time, to the current date/time, from among the time-series status information stored in the storing unit 1200 as the second status information that has not been reported to the information processing apparatus 20 in S219 to report the second status information to the second reporting unit 1242 in S221.

Next, the second reporting unit 1242 reports the second status information acquired by the second acquisition unit 1262 to the information processing apparatus 20 in S223. The second reporting unit 1242 acquires a result of reporting the second status information as a response from the information processing apparatus 20 in S225. The second reporting unit 1242 checks whether or not it has succeeded to report the second status information in S227.

Here, the operations after step S229 are performed if the second reporting unit 1242 has succeeded to report the second status information, and the operations after step S229 are not performed if the second reporting unit 1242 has failed to report the second status information.

Next, if the second reporting unit 1242 has succeeded to report the second status information, the second reporting unit 1242 requests the second acquisition unit 1262 to update the information on reported date/time in S229, and the second acquisition unit 1262 updates the date/time indicated by the information on reported date/time to the current date/time used for defining the range of the second status information (i.e., the latest date/time in the second status information) in S231 and reports to the second reporting unit 1242 that it has finished to update in S233.

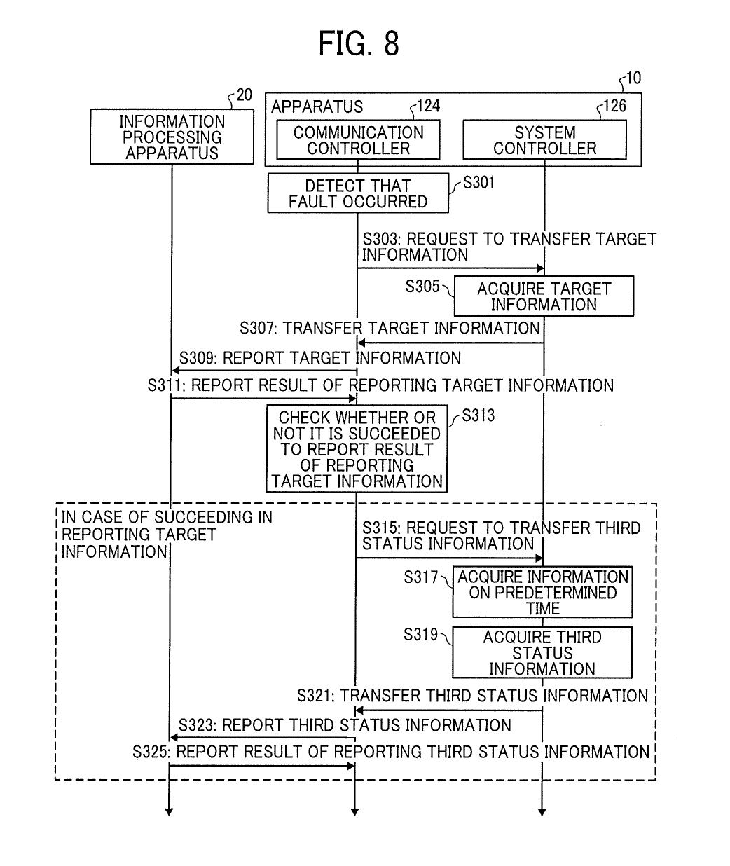

FIG. 8 is a sequence chart illustrating an operation of reporting the target information and the second status information performed by the information processing system 1 in this embodiment.

First, when the target information reporting unit 1243 in the communication controller 124 detects the malfunction occurred in the apparatus 10 in S301, the target information reporting unit 1243 requests the target information acquisition unit 1263 in the system controller 126 to acquire the target information in S303.

Subsequently, the target information acquisition unit 1263 acquires the target information in S305 and reports the target information to the target information reporting unit 1243 in S307.

Next, the target information reporting unit 1243 reports the target information acquired by the target information acquisition unit 1263 to the information processing apparatus 20 in S309, acquires a result of reporting the target information as a response from the information processing apparatus 20 in S311, and checks whether or not it has succeeded to report the target information in S313.

Here, the operations after step S315 are performed if is the target information reporting unit 1243 has succeeded to report the target information, and the operations after step S315 are not performed if the target information reporting unit 1243 has failed to report the target information.

Next, if the target information reporting unit 1243has succeeded to report the target information, the target information reporting unit 1243 reports to the second reporting unit 1242 in the communication controller 124 that it has succeeded to report the target information, and the second reporting unit 1242 requests the second acquisition unit 1262 in the system controller 126 to acquire the third status information in S315.

Next, the second acquisition unit 1262 acquires information on the predetermined time stored in the MEM-P 912 in S317. The information on the predetermined time is information indicating a value of the predetermined time from the time when the malfunction occurs, which corresponding to a time period that the status information is to be obtained as the third status information

Next, the second acquisition unit 1262 acquires status information that has obtained during the predetermined period of time, indicated by the information on the predetermine time (e.g., three hours ago), up to the time when the malfunction occurs, as the third status information, from among the time-series status information stored in the storing unit 1200 in S319, and reports the third status information to the second reporting unit 1242 in S321.

Next, the second reporting unit 1242 reports the third status information acquired by the second acquisition unit 1262 to the information processing apparatus 20 in S323 and acquires a result of reporting the third status information as a response from the information processing apparatus 20 in S325.

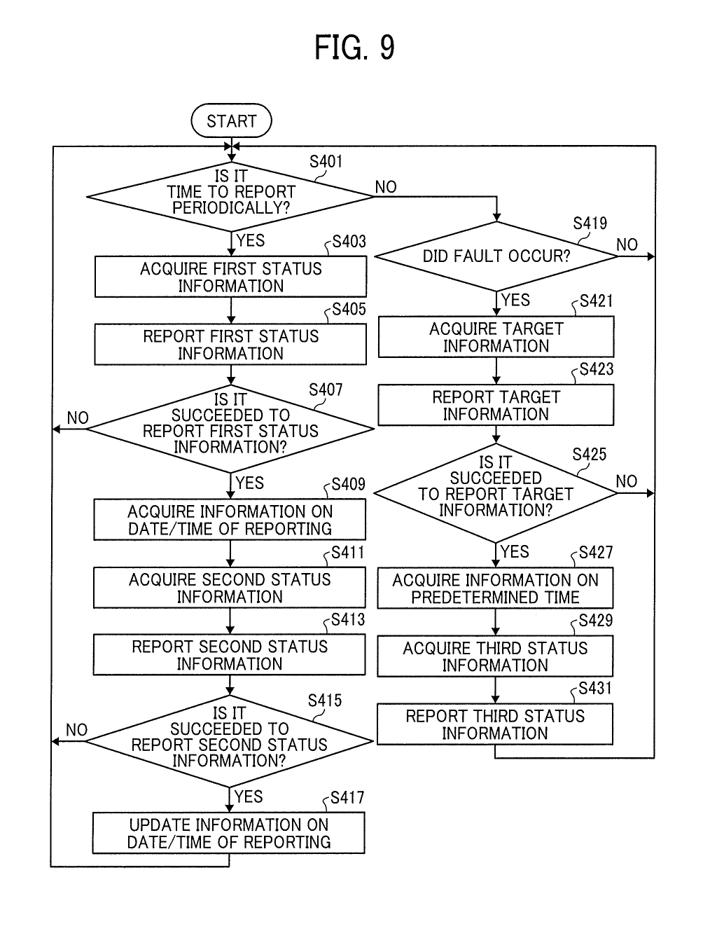

FIG. 9 is a flowchart illustrating an operation of reporting performed by the information processing system 1 in this embodiment.

First, the first reporting unit 1241 determines whether or not the regular reporting time arrives in S401.

If the regular report timing arrives (YES in S401), the first acquisition unit 1261 acquires the first status information in S403, and the first reporting unit 1241 reports the first status information to the information processing apparatus 20 in S405.

Next, after reporting the first status information, the first reporting unit 1241 determines whether or not it has succeeded to report the first status information as a response from the information processing apparatus 20 in S407. Here, if it has failed to report the first status information (NO in S407), the operation goes back to step S401.

If the first reporting unit 1241 has succeeded to report the first status information (YES in S407), the second acquisition unit 1262 acquires the information on reported date/time stored in the MEM-P 912 in S409 and acquires status information from the last date/time when it has succeeded to report the second status information indicated by the information on reported date/time, to the current date/time, from among the time-series status information stored in the storing unit 1200 as the second status information that has not been reported to the information processing apparatus 20 in S411.

Next, the second reporting unit 1242 reports the second status information acquired by the second acquisition unit 1262 to the information processing apparatus 20 in S413.

Next, after reporting the second status information, the second reporting unit 1242 determines whether or not it has succeeded to report the second status information as a response from the information processing apparatus 20 in S415. Here, if it has failed to report the second status information (NO in S415), the operation goes back to step S401.

If the second reporting unit 1242 has succeeded to report the second status information (YES in S415), the second acquisition unit 1262 updates the date/time indicated by the information on reported date/time, to the current date/time used for defining the range of the second status information (i.e., the latest date/time in the second status information) in S417 and the operation goes back to S401.

By contrast, if the current time does not reach the regular reporting time (NO in S401), the target information reporting unit 1243 determines whether or not the reporting time attributable to the malfunction in the apparatus 10 arrives in S419. If the reporting time attributable of the malfunction in the apparatus 10 does not arrive (NO in S419), the operation goes back to S401.

If the reporting time attributable to the malfunction in the apparatus 10 arrives (YES in S419), the target information acquisition unit 1263 acquires the target information in S421, and the target information reporting unit 1243 reports the target information acquired by the target information acquisition unit 1263 to the information processing apparatus 20 in S423.

Next, after reporting the target information, the target information reporting unit 1243 determines whether or not it has succeeded to report the target information as a response from the information processing apparatus 20 in S425. Here, if it has failed to report the target information (NO in S425), the operation goes back to step S401.

If the target information reporting unit 1243 has succeeded to report the target information (YES in S425), the second acquisition unit 1262 acquires the information on the predetermined time stored in the MEM-P 912 in S427, and acquires status information that has obtained during the predetermined period of time, indicated by the information on predetermine time (e.g., three hours ago), up to the time when the malfunction occurs, as the third status information, from among the time-series status information stored in the storing unit 1200 in S429.

Next, the second reporting unit 1242 reports the third status information acquired by the second acquisition unit 1262 to the information processing apparatus 20 in S431, and the operation goes back to step S401.

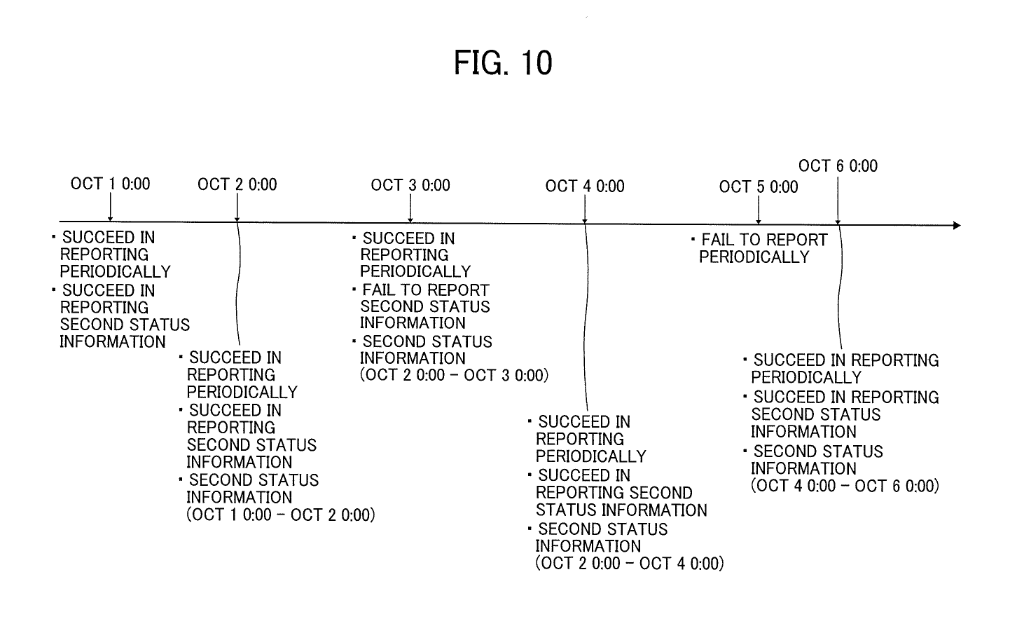

FIG. 10 is a diagram illustrating a specific operation of reporting the first status information and second status information performed by the information processing system 1 in this embodiment. Here, in FIG. 10, it is assumed that the regular reporting time used for reporting the first status information is at 0:00 every day as an example. However, the timing of reporting regularly is not limited to the example.

As illustrated in FIG. 10, at 0:00 on October 1, it is assumed that regular reporting of the first status information and reporting of the second status information after regular reporting are both successful.

Next, at 0:00 on October 2 as the subsequent regular reporting time, it is assumed that regular reporting of the first status information and reporting of the second status information after regular reporting are both successful. Here, in this case, the second status information corresponds to status information obtained, from 0:00 on October 1 when the second status information has been reported for the last time, to 0:00 on October 2 as the current date/time.

Next, at 0:00 on October 3 as the subsequent regular reporting time, regular reporting of the first status information was successful. However, reporting of the second status information failed after regular reporting. Here, in this case, the second status information corresponds to status information obtained, from 0:00 on October 2 when the second status information has been reported for the last time, to 0:00 on October 3 as the current date/time.

Next, at 0:00 on October 4 as the subsequent regular reporting time, regular reporting of the first status information was successful, and reporting of the second status information after regular reporting was successful. Here, in this case, the second status information corresponds to status information obtained, from 0:00 on October 2 when the second status information has been reported for the last time, to 0:00 on October 4 as the current date/time. That is, in reporting the second status information at 0:00 on October 4, the second status information also includes status information obtained from 0:00 on October 2 to 0:00 on October 3, which has not been reported for the last time.

As described above, if reporting of the second status information failed, the second status information is reported accordingly when the second status information is reported next time. Since the information processing apparatus 20 uses the second status information for predicting the future status of the apparatus 10, the second status information does not have to be reported immediately as long as it is reported for the next time, thus preventing the increase in network load otherwise caused by reporting again. In some times, the apparatus 10 may reboot after the regular reporting. Therefore, while regular reporting is successful, it is possible to fail to report the second status information (i.e., it is impossible to report the second status information).

Next, at 0:00 on October 5 as the subsequent regular reporting time, reporting of the first status information failed. As a result, the second status information is not reported after regular reporting.

Next, at 0:00 on October 6 as the subsequent regular reporting time, reporting of the first status information was successful, and reporting of the second status information after regular reporting was successful. Here, in this case, the second status information corresponds to status information obtained, from 0:00 on October 4 when the second status information has been successfully reported for the last time, to 0:00 on October 6 as the current date/time. That is, in reporting the second status information at 0:00 on October 6, the second status information also includes status information obtained from 0:00 on October 4 to 0:00 on October 5 that has not been reported for the last time.

As described above, if regular reporting failed, the second status information is not reported either, and the second status information is reported for the next time of reporting. Since the information processing apparatus 20 uses the second status information for predicting the future status of the apparatus 10, immediacy is not required and it is possible to prevent network load from increasing due to reporting again.

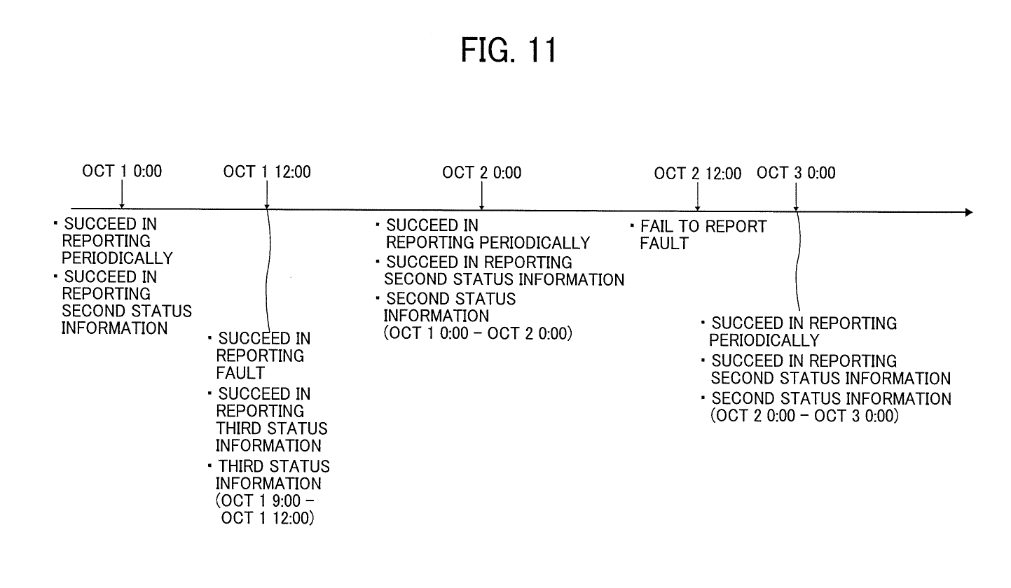

FIG. 11 is a diagram illustrating a specific operation of reporting the target information and third status information performed by the information processing system 1 in this embodiment. Here, in FIG. 11, it is assumed that the predetermined time corresponds to three hours and the third status information corresponds to status information obtained for three hours up to the date/time when the malfunction occurs as an example. However, the predetermined time is not limited to that example. In addition, in FIG. 11, for the sake of convenience, an operation of reporting the first status information and the second status information is also included. In FIG. 11, it is assumed that the regular reporting time used for reporting the first status information is at 0:00 every day as an example. However, the timing of reporting regularly is not limited to the example.

As illustrated in FIG. 11, at 0:00 on October 1, it is assumed that regular reporting of the first status information was successful and reporting of the second status information after regular reporting was successful.

Next, after the malfunction occurs in the apparatus 10 at 12:00 on October 1, reporting of the target information due to occurrence of the malfunction, and reporting of the third status information after reporting the malfunction are both successful. Here, in this case, the third status information corresponds to status information that has obtained for three hours, from 9:00 on October 1, up to the time when the malfunction occurs, that is, 12:00 on October 1.

Next, at 0:00 on October 2 as the subsequent regular reporting time, it is assumed that reporting of the first status information and reporting of the second status information after regular reporting are both successful. Here, in this case, the second status information corresponds to status information obtained, from 0:00 on October 1 when the second status information has been successfully reported for the last time to 0:00 on October 2 as the current date/time.

Next, after the malfunction occurs in the apparatus 10 at 12:00 on October 2, reporting of the target information due to the malfunction failed. As a result, reporting of the third status information is not performed after reporting the malfunction.

Next, at 0:00 on October 3 as the subsequent regular reporting time, regular reporting of the first status information and reporting of the second status information after regular reporting are both successful. Here, in this case, the second status information corresponds to status information obtained, from 0:00 on October 2 when the second status information has been successfully reported for the last time to 0:00 on October 3 as the current date/time.

As described above, in this embodiment, the first status information indicating the current status of the apparatus and the second status information corresponding to status information obtained between the reporting of the first status information are both reported. As a result, it is possible to reduce communication load and analyze the apparatus in various ways.

Likewise, in this embodiment, the target information requested to report when the malfunction occurs and the third status information corresponding to status information that has obtained during the predetermined time period up to the time when the malfunction occurs are both reported. As a result, it is possible to reduce communication load and analyze the apparatus in various ways.

Here, in this embodiment, it is proposed that the function that reports the second status information and the third status information is newly included in the apparatus (information processing system) that conventionally reports the first status information and the target information only. Therefore, the first status information and the second status information are reported similarly, and the target information and the third status information are reported similarly. As a result, it is possible to utilize resources that have been developed so far (logic that analyzes the first status information and the target information) and perform more advanced analyze.

Variation 1

In the embodiment described above, it is possible to limit data sizes (i.e., amount of data) of the second status information and the third status information.

In this case, regarding the second status information, the second acquisition unit 1262 determines whether or not a size of status information that has not been reported to the information processing apparatus 20, included in the time-series status information, exceeds a threshold value. If the size of the status information exceeds the threshold value, it is possible to acquire unreported status information having a part of information that has been deleted so that the size does not exceed the threshold value when sent as the second status information.

Similarly, regarding the third status information, the second acquisition unit 1262 determines whether or not a size of status information during the predetermined time up to the time when the malfunction occurs, included in the time-series status information, exceeds a threshold value. If the size of the status information exceeds the threshold value, it is possible to acquire unreported status information havinga part of information that has been deleted so that the size does not exceed the threshold value when sent as the second status information.

Examples of method of reducing information are deleting the time-series status information in chronological order, thinning out the time-series status information at a predetermined interval, and inquiring of the information processing apparatus 20 which information is to be deleted. However, the method of reducing information is not limited to those examples.

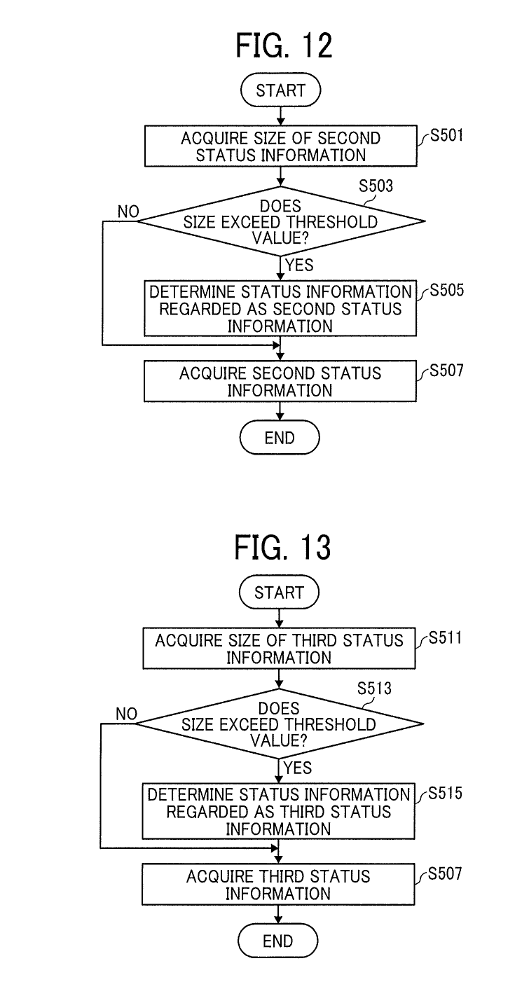

FIG. 12 is a flowchart illustrating an operation of determining the second status information performed by the apparatus 10 in this embodiment, and the operation is performed in step S411 in the flowchart illustrated in FIG. 9.

First, the second acquisition unit 1262 acquires the threshold value stored in the MEM-P 912 and acquires a size of status information from the time when it has succeeded to report the second status information for the last time, as indicated by the information on reported date/time, to the current date/time, from among the time-series status information stored in the storing unit 1200 in S501.

Next, the second acquisition unit 1262 determines whether or not the acquired size exceeds the threshold value in S503.

If the acquired size exceeds the threshold value (YES in S503), the second acquisition unit 1262 obtains status information that has been processed so that the size of the status information does not exceed the threshold value, from among the status information obtained from the date/time when it has succeeded to report the second status information for the last time, indicated by the information on reported date/time, to the current date/time, as the second status information in S505.

Next, the second acquisition unit 1262 acquires the second status information from the storing unit 1200 in S507.

By contrast, if the acquired size does not exceed the threshold value (NO in S503), the second acquisition unit 1262 acquires the status information, from the date/time when it has succeeded to report the second status information for the last time, indicated by the information on reported date/time, to the current date/time, as the second status information from the storing unit 1200 in S507.

FIG. 13 is a flowchart illustrating an operation of determining the third status information performed by the apparatus 10 in this embodiment, and the operation is performed in step S429 in the flowchart illustrated in FIG. 9.

First, the second acquisition unit 1262 acquires the threshold value stored in the MEM-P 912 and acquires a size of status information obtained during the predetermined time indicated by the information on predetermined time up to the time when the malfunction occurs, from among the time-series status information stored in the storing unit 1200 in S511.

Next, the second acquisition unit 1262 determines whether or not the acquired size exceeds the threshold value in S513.

If the acquired size exceeds the threshold value (YES in S513), the second acquisition unit 1262 obtains status information that has been processed so that the size of the status information does not exceed the threshold value, from among the status information obtained during the predetermined time (e.g., three hours ago) indicated by the information on predetermined time up to the time when the malfunction occurs as the third status information in S515.

Next, the second acquisition unit 1262 acquires the third status information from the storing unit 1200 in S517.

By contrast, if the acquired size exceeds the threshold value (NO in S513), the second acquisition unit 1262 acquires status information during the predetermined time (e.g., three hours ago) indicated by the information on predetermined time up to the time when the malfunction occurs, from the storing unit 1200 as the third status information in S517.

Variation 2

In the embodiment described above, it is possible to report the third status information in accordance with a type of malfunction.

More specifically, the second acquisition unit 1262 determines whether or not it is required to acquire the third status information based on the type of malfunction. If it is required to acquire the third status information, the status information is acquired, and the second reporting unit 1242 reports the third status information to the information processing apparatus 20.

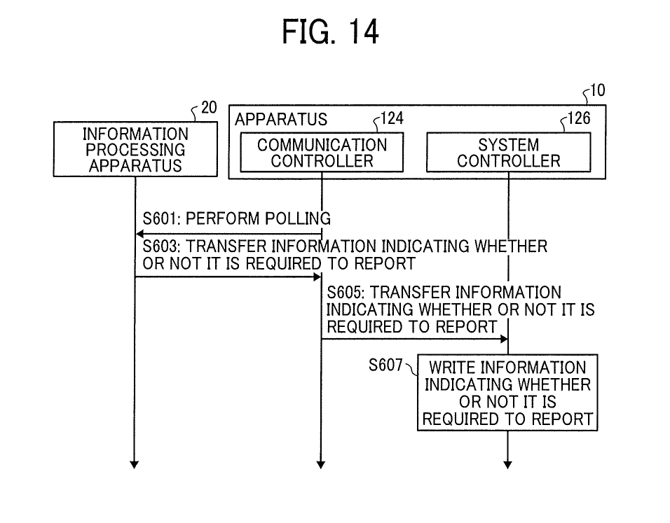

FIG. 14 is a sequence chart illustrating an operation of writing information indicating whether or not it is required to report performed by the information processing system 1 in this embodiment.

First, the second reporting unit 1242 in the communication controller 124 performs polling on the information processing apparatus 20 in S601.

Next, as a response to the polling, the communication unit 201 in the information processing apparatus 20 reports information indicating whether or not it is required to report, defining whether or not it is required to report the third status information for each type of malfunction to the apparatus 10 in S603. The second reporting unit 1242 reports the information indicating whether or not it is required to report to the system controller 126 in the apparatus 10 in S605.

Next, the second acquisition unit 1262 in the system controller 126 writes the reported information indicating whether or not it is required to report in the MEM-P 912 in S607.

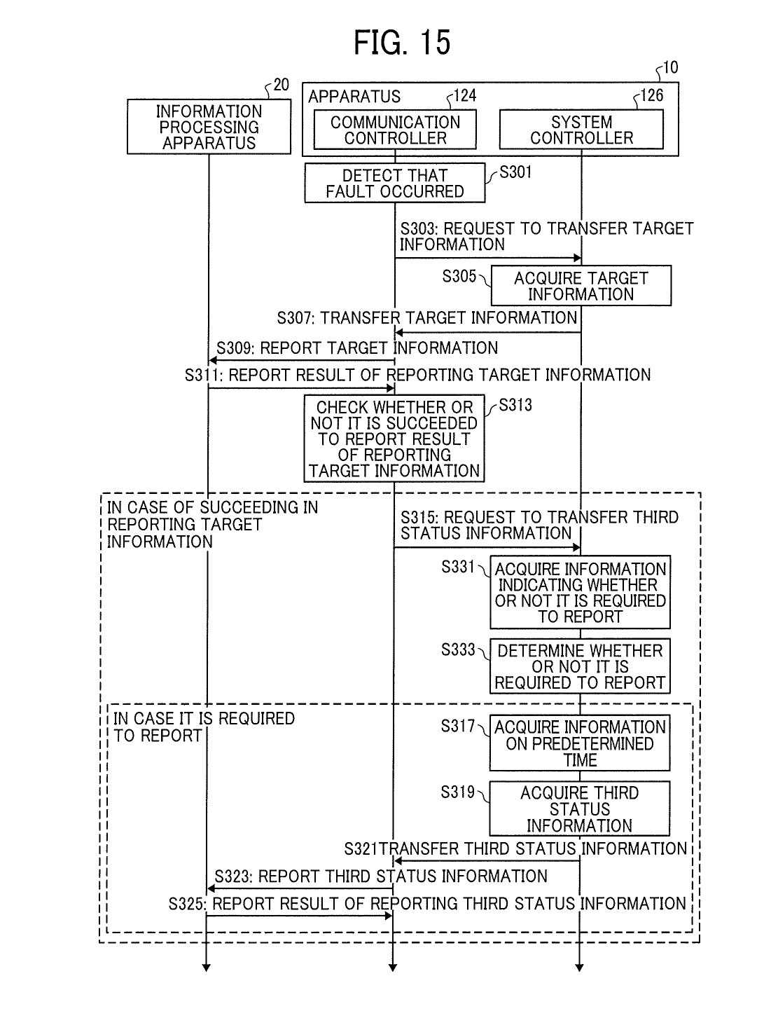

FIG. 15 is a sequence chart illustrating an operation of reporting the target information and the second status information performed by the information processing system 1 in this embodiment.

First, operations from steps S301 to S315 are similar to S301 to S315 in the sequence chart illustrated in FIG. 8.

Next, the second acquisition unit 1262 acquires information indicating whether or not it is required to report, which is stored in the MEM-P 912 in S331.

Next, with reference to the information indicating whether or not it is required to report, the second acquisition unit 1262 determines whether or not it is required to report the third status information based on the malfunction that occurs in S333.

Here, operations after step S317 are performed if it is required to report the third status information, and operations after step S317 are not performed if it is unnecessary to report the third status information.

Next, operations from steps S317 to S325 are similar to S317 to S325 of the sequence chart illustrated in FIG. 8.

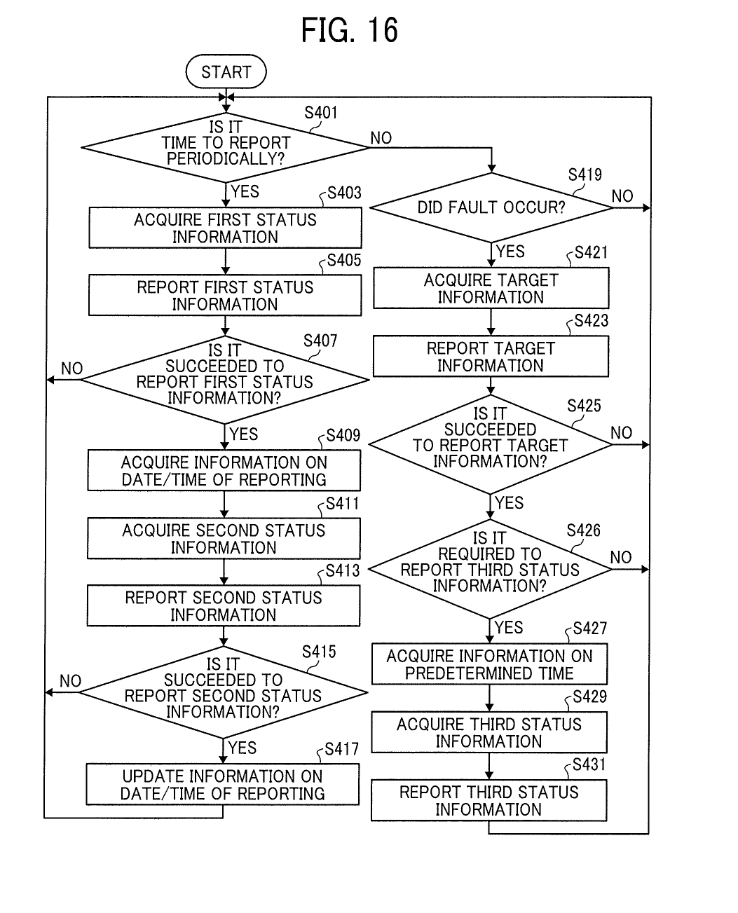

FIG. 16 is a flowchart illustrating an operation of reporting performed by the information processing system 1 in this embodiment.

First, operations from steps S401 to S425 are similar to S401 to S425 of the flowchart illustrated in FIG. 9.

Next, after acquiring the information indicating whether or not it is required to report from the MEM-P 912, the second acquisition unit 1262 determines whether or not it is required to report the third status information based on the malfunction that occurs in S426. If it is required to report the third status information (YES in S426), the operation proceeds to step S427. If it is unnecessary to report the third status information (NO in S426), the operation goes back to step S401.

Subsequently, operations from steps S427 to S431 are similar to S427 to S431 of the flowchart illustrated in FIG. 9.

Programs executed by the apparatus 10 and the information processing apparatus 20 (hereinafter referred to as “apparatuses described in the above embodiment”) described in the embodiment above are stored in computer-readable storage media such as CD-ROM, CD-R, memory card, Digital Versatile Disk (DVD), and flexible disk (FD) etc. in an installable format or an executable format and distributed.

In addition, the program executed by the apparatuses described in the above embodiment may be stored in a computer connected to a network such as the Internet etc., and the program may be provided by downloading the program via the network. Furthermore, it is possible to provide and distribute the program executed by the apparatuses described in the above embodiment via the network such as the Internet etc. Otherwise, it is possible to provide the program executed by the apparatuses described in the above embodiment by storing the program in the ROM etc. preliminarily.

Programs executed by the apparatuses described in the above embodiment have a module structure to implement the components described above on the computer. For example, as actual hardware, the functional components described above may be implemented on the computer by reading the program from the ROM into the RAM by the CPU.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

In case the above-described embodiments are implemented by software, programs executed by any apparatus in the information processing system 1 (i.e., the apparatus 10 and the information processing apparatus 20) may be stored, as a file that is installable or executable on the general-purpose computer, in a computer readable storage medium such as a compact disc read only memory (CD-ROM), a flexible disk (FD), a compact disc-recordable (CD-R), a digital versatile disc (DVD), and a universal serial bus (USB) etc. Further, the programs may be provided or distributed via a network such as the Internet etc. In addition, the various programs in this embodiment may be provided or distributed in the form of a recording medium such as a ROM, etc.

1. An apparatus, comprising:
circuitry configured to:
monitor a status of the apparatus to generate time-series status information indicating the statuses of the apparatus in chronological order;
at every regular reporting time, acquire first status information indicating the status of the apparatus at the regular reporting time, and report the first status information to an information processing apparatus via a network; and
after regular reporting of the first status information, acquire second status information that has not been reported to the information processing apparatus, from among the time-series status information being generated, and report the second status information to the information processing apparatus.

2. The apparatus according to claim 1,
wherein, when the regular reporting of the first status information has failed, the circuitry does not acquire the second status information nor does not report the second status information.

3. The apparatus according to claim 1,
wherein the circuitry:
determines whether or not a size of status information that has not been reported to the information processing apparatus, included in the time-series status information being generated, exceeds a threshold value;
when the size of the status information exceeds the threshold value, deletes a part of the status information to keep the size of the status information equal to or below the threshold value; and
acquires the status information being processed as the second status information.

4. The apparatus according to claim 1,
wherein the circuitry:
acquires, when a malfunction occurs in the apparatus, target information corresponding to the malfunction;
reports the target information to the information processing apparatus;
after reporting of the target information, acquires status information that has been obtained during a predetermined period of time up to the time when the malfunction occurs, from among the time-series status information being generated, and reports the status information during the predetermined period of time to the information processing apparatus.

5. The apparatus according to claim 4,
wherein, when reporting of the target information has failed, the circuitry does not acquire the status information, nor does not report the status information.

6. The apparatus according to claim 4,
wherein the circuitry:
determines whether or not a size of the status information during the predetermined period of time up to the time when the malfunction occurs, included in the time-series status information being generated, exceeds a threshold value;
when the size of the status information exceeds the threshold value, deletes a part of the status information to keep the size of the status information equal to or below the threshold value; and
acquires the status information being processed as the status information during the predetermined period of time.

7. The apparatus according to claim 4,
wherein the circuitry:
determines whether or not it is required to acquire the status information based on a type of the malfunction; and
acquires the status information when the circuitry determines that it is required to acquire the status information.

8. A method of processing information performed by an apparatus, the method comprising:
monitoring a status of the apparatus to generate time-series status information indicating the statuses of the apparatus in chronological order;
at every regular reporting time, acquiring first status information indicating the status of the apparatus at the regular reporting time, and report the first status information to an information processing apparatus via a network; and
after regular reporting of the first status information, acquiring second status information that has not been reported to the information processing apparatus, from among the time-series status information being generated, and reporting the second status information to the information processing apparatus.

9. The method of processing information according to claim 8, the method further comprising:
acquiring, when a malfunction occurs in the apparatus, target information corresponding to the malfunction;
reporting the target information to the information processing apparatus; and
after reporting of the target information, acquiring status information that has been obtained during a predetermined period of time up to the time when the malfunction occurs, from among the time-series status information being generated, and reporting the status information during the predetermined period of time to the information processing apparatus.

10. A non-transitory, computer-readable recording medium storing a program that, when executed by one or more processors of an apparatus, causes the processors to implement a method of processing information, the method comprising:
monitoring a status of the apparatus to generate time-series status information indicating the statuses of the apparatus in chronological order;
at every regular reporting time, acquiring first status information indicating the status of the apparatus at the regular reporting time, and report the first status information to an information processing apparatus via a network; and
after regular reporting of the first status information, acquiring second status information that has not been reported to the information processing apparatus, from among the time-series status information being generated, and reporting the second status information to the information processing apparatus.

11. The non-transitory, computer-readable recording medium according to claim 10, the method further comprising:
acquiring, when a malfunction occurs in the apparatus, target information corresponding to the malfunction;
reporting the target information to the information processing apparatus; and
after reporting of the target information, acquiring status information that has been obtained during a predetermined period of time up to the time when the malfunction occurs, from among the time-series status information being generated, and reporting the status information during the predetermined period of time to the information processing apparatus.
